(19) United States
(12) Patent Application Publication
(10) Pub. No.: US 2006/0061833 A1
(43) Pub. Date: Mar. 23, 2006

(54) Image processing device and its control method and control program

(75) Inventors: Yukiko Kikuchi, Kanagawa (JP); Masaki Kuroda, Kanagawa (JP); Yoshihiro Sekine, Kanagawa (JP); Akihito Toyoda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/068,982

(22) Filed: Mar. 2, 2005

(30) Foreign Application Priority Data
Sep. 22, 2004 (JP) 2004-275799

(51) Int. Cl. H04N 1/04

(52) U.S. Cl. 358/474

(57) ABSTRACT

An image processing device, comprising: an image reader that reads an image of an original according to a start request operation made by a user; a blank sheet detection unit which detects whether the original to be read by the image reader is a blank or not; and a display controller which causes a display to display a selection screen for processing the blank original when it is detected by the blank sheet detection unit that the original is a blank.

### BACKGROUND OF THE INVENTION

1. Field of the Invention

The present invention relates to an image processing device and its control method and control program, which execute image reading processing for reading an image on the surface of an original according to a start request operation performed by a user, and more particularly to an image processing device and its control method and control program, which detect the presence or not of a blank sheet in originals being read when the start request operation (start button is pushed) is made, and if a blank sheet is detected as the detected result, display a screen to which the user can intervene and also output a voice guide.

2. Description of the Related Art

Conventionally, image processing devices such as facsimiles, copy machines and multifunctional devices are provided with a screen for checking the contents of functions set by a user, namely a function setting confirmation screen. Therefore, the user can check the function setting status easily with reference to the function setting confirmation screen shown on a display.

But, the function setting confirmation screen is not displayed unless the user has an intension of displaying it. Therefore, an operation error of starting a job with erroneous settings has occurred frequently.

Especially, it was highly possible that, when a visually-impaired person (who is totally blind, weak sighted or decreased sighted) starts various jobs by a multifunctional device, the visually-impaired person executes a job which is contrary to the user's intension without knowing that there is a function setting error or the inclusion of a blank sheet in the originals to be read.

It is well know to provide a technology of improving operability because it has a screen on which the setting of only the set functions can be confirmed and the settings of the shown functions can be changed.

However, the above-described technology shows a function setting confirmation screen, but what is shown is limited to the changed settings. For example, if a destination of the output tray is not changed, information about an output tray from which output is made is not informed, and it was particularly difficult to operate for a visually-impaired person.

Further, it is well know to provide a technology that it can detect the presence or not of an original image and processing can be restarted by merely pushing a start button again even if a blank original is detected in error, and the occurrence of a waste such as copying time or the like caused by the erroneous detection can be suppressed to a minimum.

The above described technology can continuously execute the job when a blank sheet is detected but does not display a screen to which the user can intervene, and it was difficult for particularly a visually-impaired person to know which operation must be made after the blank sheet is detected.

Accordingly, the present invention has been made in view of the above circumstances and provides an image processing device and its control method and control program that, the presence or not of a blank sheet in originals to be read is detected, and if a blank sheet is detected as the detected result, it is displayed on a screen to which the user can intervene and a voice guide may be also output.

### SUMMARY OF THE INVENTION

An aspect of the present invention provides an image processing device, comprising: an image reader that reads an image of an original according to a start request operation made by a user; a blank sheet detection unit which detects whether the original to be read by the image reader is a blank or not; and a display controller which causes a display to display a selection screen for processing the blank original when it is detected by the blank sheet detection unit that the original is a blank.

A further aspect of the present invention provides a method of controlling an image processing device, comprising: reading an image of an original according to a start request operation made by a user; detecting whether the original to be read by the image reader is a blank or not; when it is detected that the original is a blank, displaying on a display a selection screen which includes at least two as the choices among processing of canceling a job including the blank sheet, processing of skipping the blank sheet, processing of continuing the job while reading the blank sheet, processing of changing to a double-side setting in case of a single-sided original setting and processing of skipping the blank sheet and changing to a double-sided setting in case of a single-sided original setting; and informing by a voice guide an operation procedure of the selection screen.

A still further aspect of the present invention provides a control program to cause a computer to execute processing of an image processing device, comprising: an image reading step for reading an image of an original according to a start request operation made by a user; a blank sheet detection step for detecting whether the original to be read is a blank or not; when it is detected by the blank sheet detection step that the original is a blank, a display control step for displaying on a display a selection screen which includes at least two as choices among processing of canceling a job including the blank sheet, processing of skipping the blank sheet, processing of continuing the job while reading the blank sheet, processing of changing to a double-side setting in case of a single-sided original setting and processing of skipping the blank sheet and changing to a double-sided setting in case of a single-sided original setting; and a voice guiding step for informing processing by a voice guide when the original is detected as a blank by the blank sheet detection step.

### BRIEF DESCRIPTION OF THE DRAWINGS

Embodiments of the present invention will be described in detail based on the following figures, wherein:

FIG. 1 is a block diagram showing an outline structure of a multifunctional device 1 to which the image processing device according to the present invention is applied;

FIG. 2 is a view showing an example of a screen layout (blank sheet detection informing screen) of an informing screen shown on a UI display 10;

FIG. 3A and FIG. 3B are views showing example screen layouts (job cancellation informing screens) of the informing screen shown on the UI display 10;

FIG. 4 is a view showing an example of a screen layout (a modified example of the blank sheet detection informing screen) of the informing screen shown on the UI display 10;

FIG. 5 is a flow chart illustrating an operation of control processing by the multifunctional device 1 shown in FIG. 1;

FIG. 6 is a block diagram showing an outline structure of the multifunctional device 1 according to Example 2;

FIG. 7 is a view showing an example of a screen layout (function setting confirmation screen) of the informing screen shown on the UI display 10 according to Example 2; and

FIG. 8 is a flow chart illustrating a control processing by the multifunctional device 1 according to Example 2.

### DETAILED DESCRIPTION OF THE INVENTION

Examples of the image processing device and its control method and control program according to the present invention will be described in detail with reference to the accompanying drawings.

### EXAMPLE 1

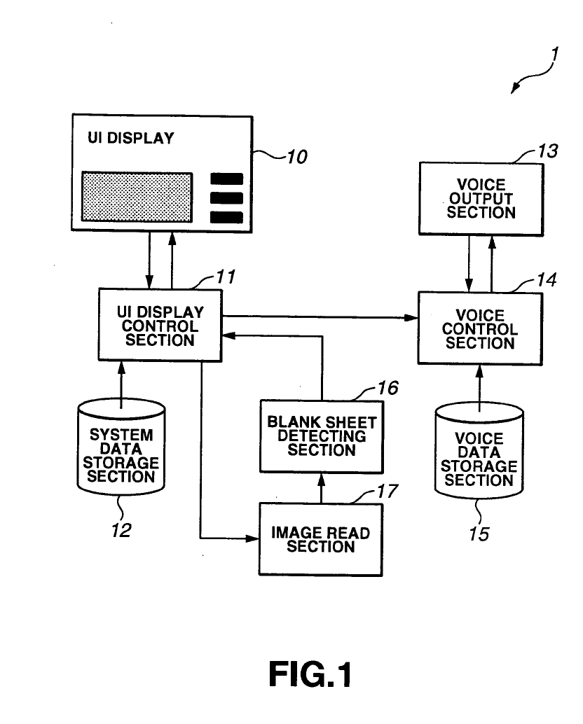

FIG. 1 is a block diagram showing an outline structure of a multifunctional device 1 to which the image processing device according to the present invention is applied. Here, only the components according to the present invention will be described.

In FIG. 1, the multifunctional device 1 is comprised of a UI (User Interface) display 10, a UI (User Interface) display control section 11, a system data storage section 12, a voice output section 13, a voice control section 14, a voice data storage section 15, a blank sheet detecting section 16, and an image read section 17 as various processing functional sections.

The UI display 10 is an operation panel provided on the device body and specifically a user interface provided with input devices such as a touch panel and operation buttons and a display device of LED (Light Emitting Diode), LCD (Liquid Crystal Display) or the like. If a blank original is detected, a screen to which the user can intervene is displayed on the display device to inform that the originals being read include a blank original.

One of the buttons arranged as the input device is a start button and, when it is pushed, image reading processing is started by the image read section 17 to be described later.

The UI display control section 11 is a processing section for controlling the above-described UI display 10. For example, it controls to display a variety of screens, which are stored in the system data storage section 12, on the UI display 10. When a user inputs a user instruction on the screen by the input device, the processing according to the user instruction is executed in conjunction with the various processing functional sections.

Upon receiving a notice that originals to be read contains a blank original from the blank sheet detecting section 16 to be described later, the UI display control section 11 obtains a screen from the system data storage section 12 and controls to display the blank sheet detection informing screen to which the user can intervene on the UI display 10.

The system data storage section 12 is a storage device for storing data which includes various screens to be displayed on the UI display 10 as described above. It also holds system data relevant to the general operation of the multifunctional device 1.

The voice output section 13 is a loud speaker provided on the device body. For example, if the originals to be read contains a blank original, that effect and a processing procedure to deal with it are notified by a voice guide, so that a visually-impaired person can also be informed of the presence of a blank sheet without fail.

The voice control section 14 is a processing section for controlling the above-described voice output section 13. Specifically, upon receiving an output instruction notice as a voice guide from the UI display control section 11, the voice control section 14 obtains the appropriate data from the various types of voice data stored in the voice data storage section 15 and outputs a voice guide from the voice output section 13.

The voice data storage section 15 is a storage device for storing various types of voice data for making voice output from the voice output section 13 as described above.

The blank sheet detecting section 16 is a processing section for detecting whether there is a blank original by analyzing the input image data which is read by the image read section 16 to be described later. Here, if a blank original is detected, it is notified to the UI display control section 11.

The image read section 17 is a processing section for reading originals and reads the originals set in a paper feed tray (not shown) or the like. Specifically, it scans the original containing pictures, characters and the like and converts the obtained information into digital data. At that time, the read input image data is passed over to the blank sheet detecting section 16. What is described above is the description about the various processing functional sections of the multifunctional device 1 according to the present invention.

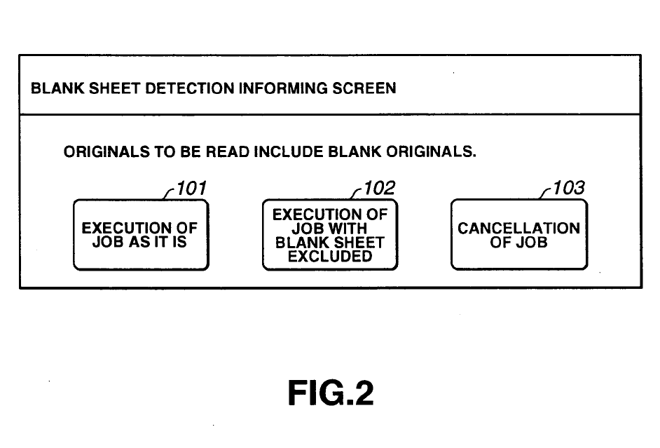

Then, the informing screen displayed on the UI display 10 shown in FIG. 1 will be described with reference to FIG. 2 to FIG. 4.

FIG. 2 shows an example of a screen layout of a blank sheet detection informing screen. The blank sheet detection informing screen is a user intervention screen which is displayed on a display device of the UI display 10 if the originals to be read include a blank original.

As shown in FIG. 2, the blank sheet detection informing screen is comprised of a button 101 for instructing the continuous execution of a job with the blank original included, a button 102 for instructing the continuous execution of a job with the blank original skipped from reading, and a button 103 for instructing the cancellation of the job being executed as user intervention means.

When the blank sheet detection informing screen is displayed, the voice output section 13 outputs a voice guide, “Blank sheet was detected. Enter a user instruction by touching one of buttons shown on the screen.” Subsequently, an operation procedure on the blank sheet detection informing screen is voice guided. Input of a user instruction is urged by a voice guide, for example, “To continue the execution of the job as it is, push the button positioned on the left side in the screen. If the job is to be executed with the blank sheet removed, push the button positioned at the center in the screen. If the job is to be cancelled, push the button positioned on the right in the screen.”

The user finds from the indication on the blank sheet detection informing screen or the voice guide that the originals include a blank sheet. Here, if the user pushes the button 102 to instruct the continuation of the job with the blank sheet removed and if all the originals are blank sheets, there is no original to be read, so that the job is cancelled.

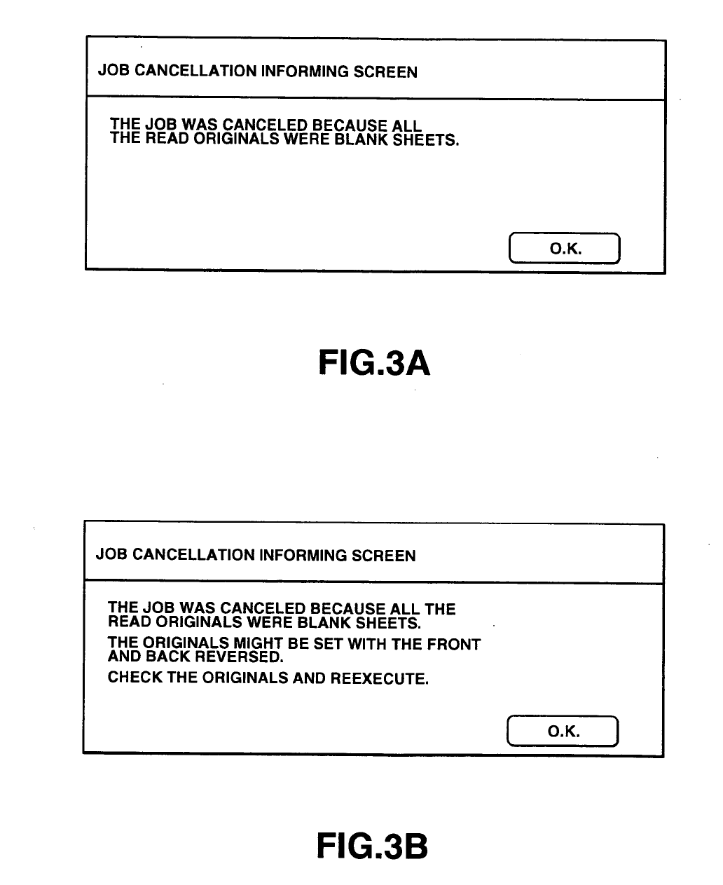

In such a case, the UI display control section 11 shows the job cancellation informing screen shown in FIG. 3A on the UI display 10.

FIG. 3A and FIG. 3B are examples of screen layouts of the job cancellation informing screen. Here, job cancellation informing screens (FIG. 3A) and (FIG. 3B) having different message contents indicated will be described.

The job cancellation informing screen shown in FIG. 3A indicates a message, “All the read originals were blank sheets, and the job was cancelled.” and the cancellation of the job is informed to the user.

And, when the job cancellation informing screen is shown, a voice guide, “The job was executed with the blank originals removed, but the job was cancelled because all the read originals were blank sheets.” is output by the voice output section 13.

Subsequently, the job cancellation informing screen shown in FIG. 3B shows a message, “The job was cancelled because all the read originals were blank sheets. The originals might be set with the front and back reversed. Check the originals and reexecute.” to give information about the cancellation of the job and urges the user to reexecute the job with the originals set with the front and back reversed.

And, in the same way as in FIG. 3A, when the job cancellation informing screen is displayed, a voice guide, “The job was executed with the blank originals removed, and the job was cancelled because all the read originals were blank sheets. The originals might be set with the front and back reversed. Check the originals and reexecute.” is output by the voice output section 13.

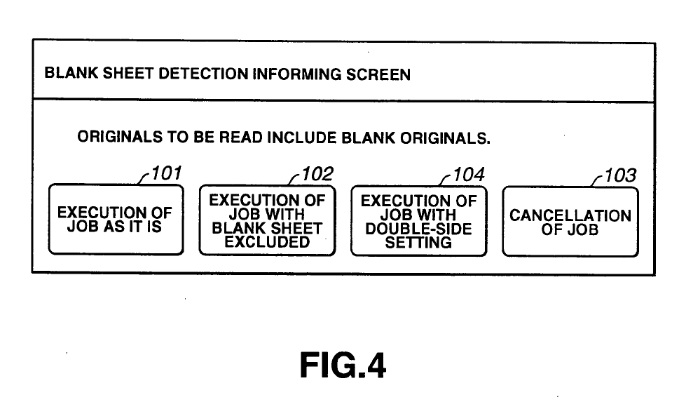

FIG. 4 is a view showing a modification of the blank sheet detection informing screen described with reference to FIG. 2. It is to be understood that the same reference numerals are allotted to the same elements as those shown in FIG. 2, and their descriptions are omitted.

The blank sheet detection informing screen shown in FIG. 4 has the same structure as that of the screen described with reference to FIG. 2 except that a button 104 for instructing the reexecution of the job with a double-side setting is added.

This job execution button 104 with the double-side setting is a button used to deal with a case that there is a possibility of detecting a blank sheet because the original was set with the front and back reversed when the original was read with a single-side setting. Specifically, when this button 104 is pushed, the original is read with the double-side setting while excluding a blank surface from the original.

It may be configured such that the originals are read with a blank original included and with the double-side setting when the job execution button 104 is pushed with the double-side setting.

A button for a function of reexecution of the job with all the originals set with the front and back reversed may be disposed instead of the job execution button 104 with this double-side setting.

As described above, the present invention informs the user with the inclusion of a blank original in the read originals and an operation procedure after the detection of the blank original by displaying such a screen or giving a voice guide. Therefore, the user can easily recognize the inclusion of the blank original and can operate easily after the detection of the blank sheet.

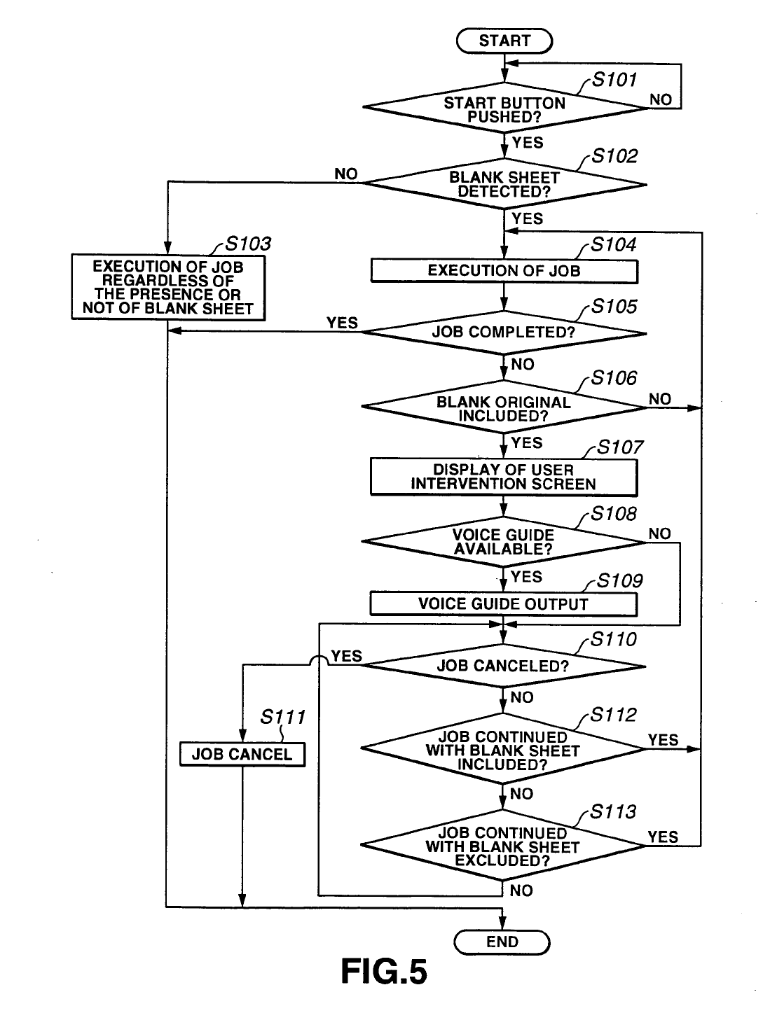

FIG. 5 is a flow chart illustrating an operation of the control processing by the multifunctional device 1 shown in FIG. 1.

In FIG. 5, this control processing is started when the start button is pushed with the originals to be read set in the paper feed tray or the like of the multifunctional device 1 (YES in step S101).

When the control processing is started, it is judged whether the blank sheet is detected or not (step S102). When the start button disposed on the UI display 10 is pushed, the UI display control section 11 refers to information on the presence or not of blank sheet detection which is previously set in the system data storage section 12 to judge whether the blank sheet is detected or not.

Here, if no blank sheet detection is set in the system data storage section 12 (NO in step S102), the image read section 17 executes original read processing regardless of the presence or absence of the blank original (step S103) and terminates this control processing after the multifunctional device 1 completes the prescribed processing. Specifically, a start button push notice is given by the UI display control section 11, and the image reading processing is started and executed by the image read section 17. At that time, the read input image data is not passed over to the blank sheet detecting section 16, but the job is executed regardless of the presence or not of the blank original.

Meanwhile, if the system data storage section 12 is set to have blank sheet detection available (YES in step S102), it executes processing of detecting the blank sheet and original read processing (step S104). Specifically, upon receiving the start button push notice from the UI display control section 11, the image read section 17 starts to execute the image reading processing. At that time, the read input image data is passed over to the blank sheet detecting section 16 to execute the blank original detection processing.

And, if the read originals do not contain a blank original and the original read processing is completed (YES in step S105), this control processing is terminated after the prescribed processing by the multifunctional device 1 is completed, but if a blank original is detected during the original read processing (NO in step S105, and YES in step S106), the detection of the blank sheet is noticed from the blank sheet detecting section 16 to the UI display control section 11.

The UI display control section 11 having received the blank sheet detection notice from the blank sheet detecting section 16 controls to display the user intervention screen about the detection of the blank sheet as shown in FIG. 2 on the UI display 10 (step S107) and refers to the information on the presence or not of a voice guide, which is previously set in the system data storage section 12, to judge whether the voice guide is output or not (step S108).

Here, if no voice guide is set in the system data storage section 12 (NO in step S108), input of the user instruction from the UI display 10 is waited, but if a voice guide available is set in the system data storage section 12 (YES in step S108), an output instruction notice is given by a voice guide from the UI display control section 11 to the voice control section 14. Upon receiving the output instruction notice, the voice control section 14 obtains appropriate data from various voice data stored in the voice data storage section 15 and outputs a voice guide from the voice output section 13 (step S109).

For example, this voice guide outputs a message, “A blank sheet was detected. Enter a user instruction by pushing one of the buttons shown on the screen.” and urges input of a user instruction by a message, “If desired to continue the execution of the job as it is, push the button positioned on the left side in the screen. If desired to execute the job with the blank sheet excluded, push the button positioned at the center in the screen. If desired to cancel the job, push the button positioned on the right side in the screen.”

If the user recognizes by the above-described processing that the read originals contain a blank sheet in view of the screen shown on the UI display 10 or the voice guide, the user selects according to the voice guide, whether the job is cancelled, the reading processing is continued with the blank original included or the reading processing is continued with the blank original excluded. In other words, the user pushes any of the buttons (reference numerals 101 to 103) disposed on the blank sheet detection informing screen shown in FIG. 2.

If the job cancel button 103 is pushed by the user (YES in step S110), the multifunctional device 1 cancels the job being executed (step S111) and terminates the control processing. But, if the user pushes the execution button 101 to continue the job as it is (NO in step S110, then YES in step S112), the job is continuously executed with the blank original included.

If the user pushes the job execution button 102 with the blank sheet excluded (NO in step S112, then YES in step S113), the job is continuously executed with the blank original excluded. And, all the originals set in the paper feed tray are read (YES in step S104), and the prescribed processing by the multifunctional device 1 is completed. Then, this control processing is terminated.

As described above, the present invention is configured to detect the presence or not of a blank sheet in the originals to be read and, if the blank sheet is detected as the detected result, outputs a voice guide while displaying a screen to which the user can intervene. Therefore, the operability by all users including visually-impaired persons can be improved.

### EXAMPLE 2

In addition to the control method of Example 1, Example 2 describes an embodiment of showing a screen on which function settings can be checked or executing a voice guide when the start button is pushed.

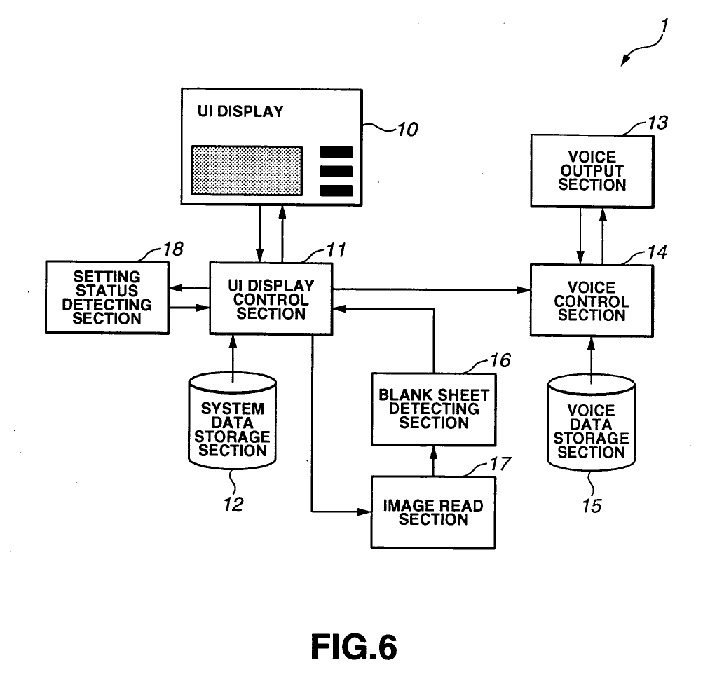

FIG. 6 is a block diagram showing an outline structure of the multifunctional device 1 in Example 2, which is configured with a setting status detecting section 18 added to the structure of FIG. 1 described in Example 1. It is to be understood that the same reference numerals are allotted to the same elements as those shown in FIG. 1, and their descriptions are omitted because they operate in the same way.

The setting status detecting section 18 is a processing section for detecting the set values of various functions set at present in the multifunctional device 1 when the start button is pushed. For example, it detects the function set values related to a setting of a paper ejection destination, a setting of a paper size at the time of output, a setting of a magnification and the like of a copy machine. And, the detected results are noticed to the UI display control section 11.

When the start button is pushed, the UI display control section 11 controls to display a function setting confirmation screen, on which the set values of various functions currently set in the multifunctional device 1 can be checked, on the UI display 10. Specifically, the set values of various functions detected by the above-described setting status detecting section 18 are displayed as a list on the function setting confirmation screen.

When the voice control section 14 receives an output instruction notice by a voice guide from the above-described UI display control section 11, it obtains appropriate data from the various voice data stored in the voice data storage section 15 and outputs a voice guide from the voice output section 13. For example, the set values of various functions shown on the function setting confirmation screen are voice guided sequentially.

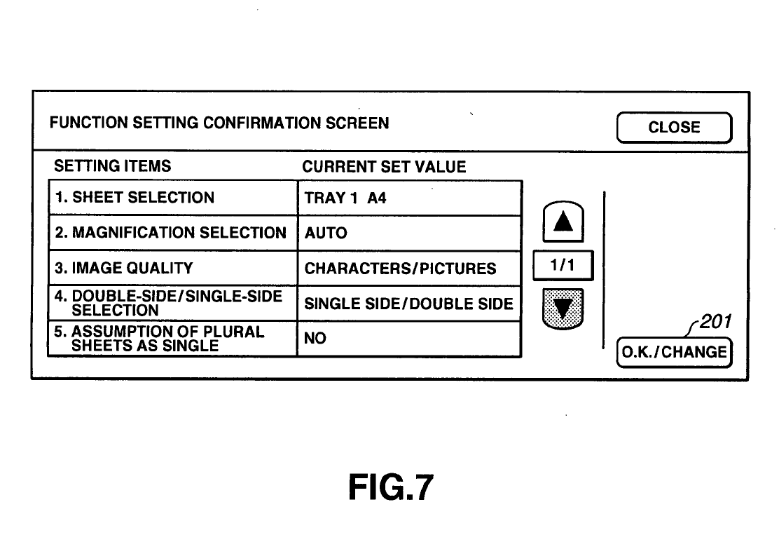

Then, the function setting confirmation screen to be shown on the UI display 10 will be described with reference to FIG. 7.

FIG. 7 shows an example of the screen layout of the function setting confirmation screen. The function setting confirmation screen is a screen which is shown when the start button is pushed and urges the user to check the function settings.

The function setting confirmation screen shows the current set values in correspondence with the setting items such as sheet selection, magnification selection, image quality, double-side/single-side selection, assumption of plural sheets as a single. In this case, all items of the function set values related to the copying functions are displayed. A decision/change button 201 is disposed on the lower right side in the screen and can change the set value of a function which is set a value contrary to what is intended by the user.

When the function setting confirmation screen is displayed, the voice output section 13 outputs a voice guide, “The settings of the current set functions are checked.” and performs a voice guide of a function setting status. For example, the user is informed of the current function setting status without fail by a voice guide, “For the sheet, A4 size sheets set in a tray 1 are selected. For the magnification, auto selection is set.”

As described above, the screen display or the voice guide can be executed by the present invention to prevent a function setting error or the like and to enhance operational convenience. For example, when the multifunctional device 1 is provided with an ordinary output tray and a finisher tray and executes copying with a finisher function such as a punch, a stapler or the like set, copies are ejected to the finisher tray. Meanwhile, if a postprocessing setting is not made, copies are ejected into the ordinary output tray. Therefore, a visually-impaired person or the like is particularly hard to know in which output tray the copied sheets are ejected. Accordingly, the operational convenience can be enhanced by informing by the function setting confirmation screen or the voice guide.

A sheet saving button may be disposed on the above-described function setting confirmation screen. In that case, if the user pushes the sheet saving button, the user is informed of a function setting capable of saving the sheets most at the execution of the job. For example, a screen display or a voice guide, “Sheets can be saved considerably by using double-sided copying and a Nup function.” is output.

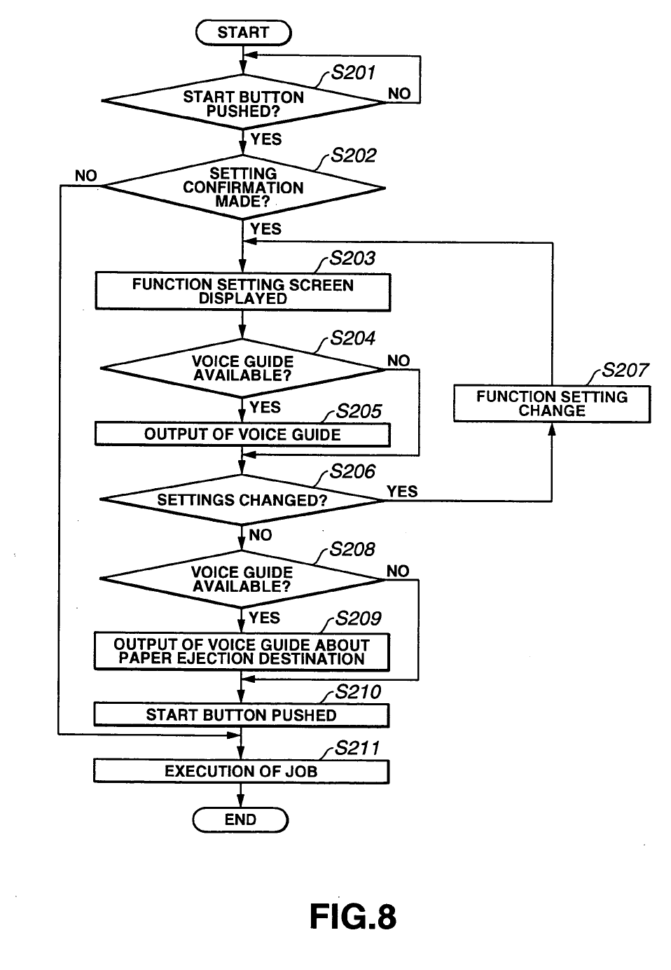

FIG. 8 is a flow chart illustrating an operation of control processing by the multifunctional device 1 shown in FIG. 6.

In FIG. 8, this control processing is started when the start button is pushed with originals to be read set in the paper feed tray or the like of the multifunctional device 1 (YES in step S201).

When this control processing is started, it is judged first whether the setting confirmation is made or not (step S202). In other words, when the start button disposed on the UI display 10 is pushed, the UI display control section 11 refers to the information on the presence or not of setting confirmation which is previously set in the system data storage section 12 to judge whether the setting confirmation is executed or not.

Here, if no setting confirmation is set in the system data storage section 12 (NO in step S202), the image read section 17 executes original read processing (step S211) and, after the termination of the prescribed processing by the multifunctional device 1, terminates this control processing. Specifically, a start button push notice is given from the UI display control section 11 and, at the same time, image reading processing is started and executed by the image read section 17.

Meanwhile, if setting confirmation available is set in the system data storage section 12 (YES in step S202), the function setting confirmation screen shown in FIG. 7 is displayed (step S203). Specifically, when the start button push notice is received from the UI display control section 11, the setting status detecting section 18 detects the set values of the currently set various functions and sends the detected results to the UI display control section 11. The UI display control section 11 displays the function setting confirmation screen having the detected results as a list on the UI display 10.

Subsequently, the UI display control section 11 refers to the information on the presence or not of a voice guide previously set in the system data storage section 12 to judge whether a voice guide is output or not (step S204).

Here, if no voice guide is set in the system data storage section 12 (NO in step S204), input of a user instruction from the UI display 10 is waited. Meanwhile, if a voice guide available is set in the system data storage section 12 (YES in step S204), a voice guide output instruction notice is made from the UI display control section 11 to the voice control section 14. Upon receiving the output instruction notice, the voice control section 14 obtains appropriate data from the various voice data stored in the voice data storage section 15 and outputs a voice guide from the voice output section 13 (step S205).

For example, when the function setting confirmation screen shown in FIG. 7 is displayed, the voice guide output a message, “The settings of the current set functions are checked.” and the user is informed of the current function setting status without fail by a voice guide, “For the sheet, A4 size sheets set in the tray 1 are selected. For the magnification, auto selection is set.”

The user having recognized the current function setting status by virtue of the screen displayed on the UI display 10 or the voice guide by the above-described processing judges whether a function setting change is made or not (step S206).

If the user desires to change the settings as a result of referring to the function setting confirmation screen (step S206), the user operates to change the settings on the function setting confirmation screen (step S207). Then, the procedure returns to step S203, the user checks the setting status again with reference to the function setting confirmation screen, but if the user judges that it is not necessary to make a setting change as a result of referring to the function setting confirmation screen (NO in step S206), the multifunctional device 1 judges whether a voice guide is executed about a paper ejection destination (step S208). In other words, the same processing as that of the above-described step S204 is executed.

As a result of step S208, if the voice guide is not executed (NO in step S208), it is waited that the start button is pushed again, but if a voice guide is executed as a result of step S208 (YES in step S208), the paper ejection destination is output by a voice guide. In other words, if postprocessing is selected by a setting operation made by the user, the paper ejection destination tray is changed, so that the change is informed.

And, the multifunctional device 1 waits that the start button is pushed, and when the start button is pushed by the user (step S210), processing to read the originals is executed by the image read section 17 (step S211), and after the prescribed processing by the multifunctional device 1 is completed, this control processing is terminated.

As described above, it is configured in Example 2 to show a screen allowing to check the function settings or to make the voice guide when the start button is pushed in addition to the control processing in Example 1, so that a function setting error can be prevented and operational convenience can be enhanced.

In the above-described Example, it was described that the image processing device according to the present invention was applied to the multifunctional device 1. But, it may be configured that the control method of the image processing device is executed by the control program installed in the multifunctional device 1.

The image processing device according to the present invention can be applied to not only the multifunctional device but also to general image processing devices such as facsimiles and copy machines having the image reading device.

The image processing device and its control method and control program of the present invention can be applied to general image processing devices having an image reading device, and when a blank original is read, informs that effect by means of a screen or a voice guide. Thus, the invention provides a system particularly effective for a beginner user and a visually-impaired person.

The entire disclosure of Japanese Patent Application No. 2004-275799 filed on Sep. 22, 2004 including specification, claims, drawings and abstract is incorporated herein by reference in its entirety.

What is claimed is:

1. An image processing device, comprising:
an image reader that reads an image of an original according to a start request operation made by a user;
a blank sheet detection unit which detects whether the original to be read by the image reader is a blank or not; and
a display controller which causes a display to display a selection screen for processing the blank original when it is detected by the blank sheet detection unit that the original is a blank.

2. The image processing device according to claim 1, further comprising a voice guiding unit which informs processing by a voice guide when the original is detected as a blank by the blank sheet detection unit.

3. The image processing device according to claim 1, wherein the display controller causes to display a selection screen which includes at least two as choices among processing of canceling a job including the blank sheet, processing of skipping the blank sheet, processing of continuing the job while reading the blank sheet, processing of changing to a double-side setting in case of a single-sided original setting, and processing of skipping the blank sheet and changing to a double-side setting in case of the single-sided original setting.

4. The image processing device according to claim 1, further comprising an informing unit which informs that a job is cancelled when the blank sheet detection unit detects that all the originals are blank and the job is cancelled.

5. The image processing device according to claim 1, further comprising an informing unit which informs that all the originals read by the image reader shall be turned over and read again when the blank sheet detection unit detects that all the originals are blank.

6. The image processing device according to claim 1, further comprising:
an operation detection unit which detects the start request operation, wherein the display controller causes a display to display a setting confirmation screen for processing the image read by the image reader in accordance with the detection of the start request operation by the operation detection unit.

7. The image processing device according to claim 6, further comprising an informing unit which informs processing of the image read by the image reader by a voice guide.

8. A method of controlling an image processing device, comprising:
reading an image of an original according to a start request operation made by a user;
detecting whether the original to be read by the image reader is a blank or not;
when it is detected that the original is a blank, displaying on a display a selection screen which includes at least two as the choices among processing of canceling a job including the blank sheet, processing of skipping the blank sheet, processing of continuing the job while reading the blank sheet, processing of changing to a double-side setting in case of a single-sided original setting and processing of skipping the blank sheet and changing to a double-sided setting in case of a single-sided original setting; and
informing by a voice guide an operation procedure of the selection screen.

9. A control program to cause a computer to execute processing of an image processing device, comprising:
an image reading step for reading an image of an original according to a start request operation made by a user;
a blank sheet detection step for detecting whether the original to be read is a blank or not;
when it is detected by the blank sheet detection step that the original is a blank, a display control step for displaying on a display a selection screen which includes at least two as choices among processing of canceling a job including the blank sheet, processing of skipping the blank sheet, processing of continuing the job while reading the blank sheet, processing of changing to a double-side setting in case of a single-sided original setting and processing of skipping the blank sheet and changing to a double-sided setting in case of a single-sided original setting; and
a voice guiding step for informing processing by a voice guide when the original is detected as a blank by the blank sheet detection step.
